(19) United States
(12) Patent Application Publication
(10) Pub. No.: US 2024/0359552 A1
(43) Pub. Date: Oct. 31, 2024

(54) ELECTRIC DRIVE DEVICE

(71) Applicant: DENSO CORPORATION, Kariya-city (JP)

(72) Inventor: KIYOSHI FUJII, Kariya-city (JP)

(21) Appl. No.: 18/767,615

(22) Filed: Jul. 9, 2024

Related U.S. Application Data
(63) Continuation of application No. PCT/JP2022/045849, filed on Dec. 13, 2022.

(30) Foreign Application Priority Data
Jan. 11, 2022 (JP) 2022-002500

(51) Int. Cl. B60K 7/00; A61G 5/04; A61G 5/10; B60K 1/00; B60K 17/04; B60L 15/00; B60L 15/20; F16H 1/20; F16H 57/02; F16H 57/021; F16H 63/34; H02K 7/102; H02K 7/116; H02K 11/33; H02K 21/14

(52) U.S. Cl. CPC B60K 7/0007; A61G 5/041; A61G 5/101; B60K 1/00; B60K 17/043; B60L 15/007; B60L 15/20; F16H 1/20; F16H 57/021; F16H 63/3416; H02K 7/1025; H02K 7/116; H02K 11/33; H02K 21/14; B60K 2001/001; B60K 2007/0061; B60L 2200/24; B60L 2200/34; B60L 2240/421; B60L 2240/423; F16H 2057/02034; F16H 2057/02052; H02K 2207/03

(57) ABSTRACT

An electric drive device includes an electric motor and a speed reducer. The electric motor includes a rotor, a stator, an electrical power converter and a motor housing. The electrical power converter is electrically connected to stator windings of the stator and is configured to supply an electric current to the stator windings. The motor housing receives the rotor, the stator and the electrical power converter. The speed reducer includes: a motor-side rotatable body that is coupled to a shaft of the rotor; and a drive-side rotatable body. The speed reducer is configured to reduce a rotational speed of the drive-side rotatable body relative to a rotational speed of the motor-side rotatable body. The motor housing and the speed reducer are integrally formed together.

### CROSS REFERENCE TO RELATED APPLICATIONS

This application is a continuation application of International Patent Application No. PCT/JP2022/045849 filed on Dec. 13, 2022, which designated the U.S. and claims the benefit of priority from Japanese Patent Application No. 2022-002500 filed on Jan. 11, 2022. The entire disclosures of all of the above applications are incorporated herein by reference.

### TECHNICAL FIELD

The present disclosure relates to an electric drive device.

### BACKGROUND

There has been proposed an electric drive device that includes an electric motor and a speed reducer which are integrally formed together.

An electrical power converter, which is electrically connected to stator windings of the electric motor, is required to drive the electric motor. In a case where the electrical power converter and the electric motor are separated from each other, electrical wirings, which electrically connect between the electric motor and the electrical power converter, may become complicated, and the structure of the electric drive device may become more complex.

### SUMMARY

This section provides a general summary of the disclosure, and is not a comprehensive disclosure of its full scope or all of its features.

According to the present disclosure, there is provided an electric drive device including an electric motor and a speed reducer. The electric motor includes a rotor, a stator, an electrical power converter and a motor housing. The electrical power converter is electrically connected to a plurality of stator windings of the stator and is configured to supply an electric current to the plurality of stator windings. The motor housing is shaped in a tubular form which is elongated in an extending direction of a shaft of the rotor. The motor housing receives the rotor, the stator and the electrical power converter in a space inside the motor housing The speed reducer is configured to reduce a rotational speed of a drive-side rotatable body relative to a rotational speed of a motor-side rotatable body at the speed reducer.

### BRIEF DESCRIPTION OF DRAWINGS

The drawings described herein are for illustrative purposes only of selected embodiments and not all possible implementations, and are not intended to limit the scope of the present disclosure.

FIG. 1 is a diagram showing an overall structure of an electric wheelchair of a first embodiment.

FIG. 2 is a diagram showing a drive unit.

FIG. 3 is a diagram showing an internal structure of an electric motor and a speed reducer.

FIG. 4 is a cross-sectional view taken along line 4-4 in FIG. 3.

FIG. 5 is a diagram showing an electrical structure of the drive unit.

FIG. 6 is a diagram showing a drive unit of a modification of the first embodiment.

FIG. 7 is a diagram showing a state where a shaft is inserted through a through-hole of a control circuit board.

FIG. 8 is a diagram showing a drive unit of a second embodiment.

FIG. 9 is a diagram showing a drive unit of a modification of the second embodiment.

FIG. 10 is a diagram showing a drive unit of another modification of the second embodiment.

FIG. 11 is a diagram showing a braking device of another modification of the second embodiment.

FIG. 12 is a diagram showing an overall structure of a senior car of a third embodiment.

FIG. 13 is a diagram showing a drive unit.

FIG. 14 is a diagram showing an internal structure of a speed reducer.

FIG. 15 is a diagram showing an overall structure of an automated guided vehicle of a fourth embodiment.

FIG. 16 is a diagram showing a drive unit.

FIG. 17 is a diagram showing the automated guided vehicle in a forward traveling state.

FIG. 18 is a diagram showing the automated guided vehicle in a braking state.

FIG. 19 is a diagram showing the automated guided vehicle in a turning state.

FIG. 20 is a diagram showing a drive unit of another embodiment.

FIG. 21 is a diagram showing a drive unit of another embodiment.

FIG. 22 is a diagram showing a drive unit of another embodiment.

### DETAILED DESCRIPTION

There has been proposed an electric drive device that includes an electric motor and a speed reducer which are integrally formed together.

An electrical power converter, which is electrically connected to stator windings of the electric motor, is required to drive the electric motor. In a case where the electrical power converter and the electric motor are separated from each other, electrical wirings, which electrically connect between the electric motor and the electrical power converter, may become complicated, and the structure of the electric drive device may become more complex.

According to the present disclosure, there is provided an electric drive device including:
an electric motor that includes:
   a rotor;
   a stator that is radially opposed to the rotor;
   an electrical power converter that is electrically connected to a plurality of stator windings of the stator and is configured to supply an electric current to the plurality of stator windings when a switching control operation of the electrical power converter is executed; and
   a motor housing that is shaped in a tubular form which is elongated in an extending direction of a shaft of the rotor, wherein the motor housing receives the rotor, the stator and the electrical power converter in a space inside the motor housing; and
a speed reducer that includes:
   a motor-side rotatable body that is coupled to the shaft; and
   a drive-side rotatable body, wherein the speed reducer is configured to reduce a rotational speed of the drive-side rotatable body relative to a rotational speed of the motor-side rotatable body, wherein:

the motor housing and the speed reducer are integrally formed together.

According to the present disclosure, the rotor, the stator and the electrical power converter are received in the motor housing that is integrally formed with the speed reducer. Therefore, the electrical wirings, which electrically connect the plurality of stator windings to the electrical power converter, can be received in the motor housing, and thereby the structure of the electric drive device can be simplified.

Hereinafter, embodiments of the present disclosure will be described with reference to the drawings.

### First Embodiment

A first embodiment, in which an electric drive device (serving as a driving power source) of the present disclosure is applied to a compact mobility (also referred to as a compact vehicle), will now be described. The compact mobility of the present embodiment is an electric wheelchair which is an electric vehicle.

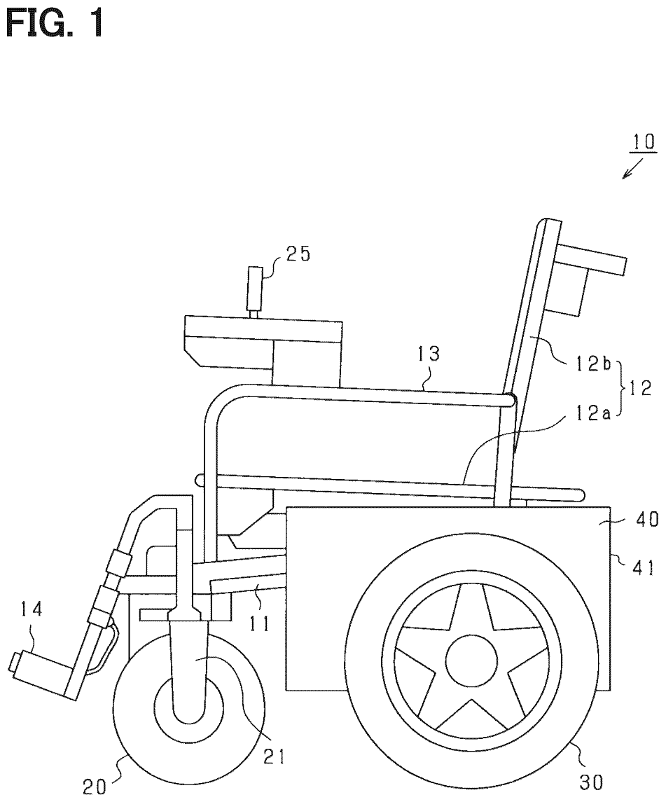

As shown in FIG. 1, the electric wheelchair 10 includes a vehicle body frame 11 and a seat 12. The seat 12 is fixed to the vehicle body frame 11. The seat 12 includes a seat portion 12a and a backrest portion 12b. The electric wheelchair 10 also includes two armrests (left and right armrests) 13 and a footrest 14 which are fixed to the vehicle body frame 11.

The electric wheelchair 10 is a four-wheeled wheelchair and includes: two brackets (left and right brackets) 21 installed to a front side of the vehicle body frame 11; left and right front wheels 20 installed to the brackets 21, respectively; and left and right rear wheels 30. In the present embodiment, the left and right front wheels 20 are steering wheels.

The electric wheelchair 10 includes a drive unit 40. The drive unit 40 includes an enclosure 41 that is fixed to the vehicle body frame 11. The enclosure 41 is placed on the lower side of the seat portion 12a.

The electric wheelchair 10 includes a manipulator 25 that is manipulated by a user. The manipulator 25 is fixed to one of the armrests 13. In the present embodiment, the manipulator 25 is a joystick which projects upward. The manipulator 25 is a member that commands a forward traveling, a backward traveling or a turn traveling of the electric wheelchair 10.

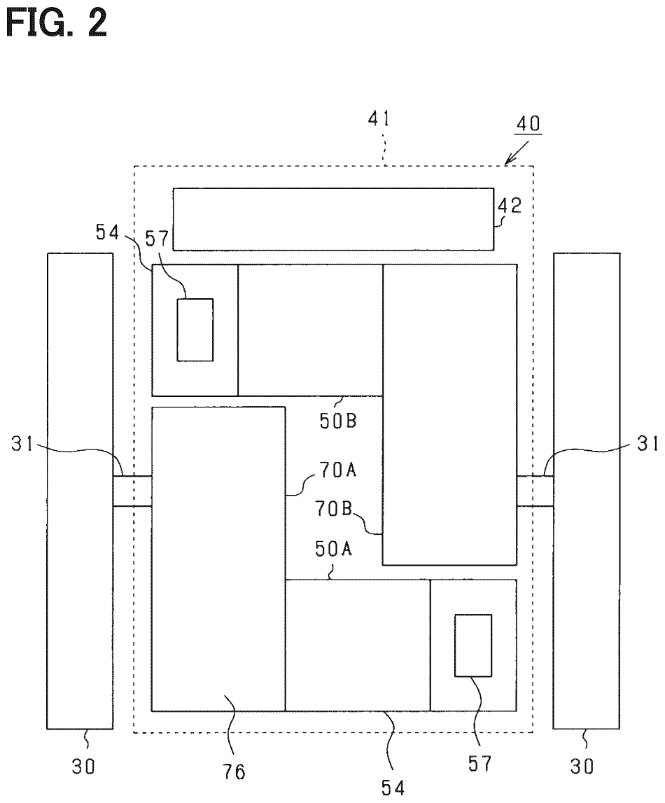

With reference to FIG. 2, an internal structure of the enclosure 41 of the drive unit 40 will be described.

The enclosure 41 receives a first electric motor 50A, a first speed reducer 70A, a second electric motor 50B, a second speed reducer 70B and an electricity storage device 42. The electricity storage device 42 is a secondary battery, such as a lithium-ion storage battery. Although FIG. 2 shows the electricity storage device 42 placed at the front side of the enclosure 41, the present disclosure is not limited to this arrangement.

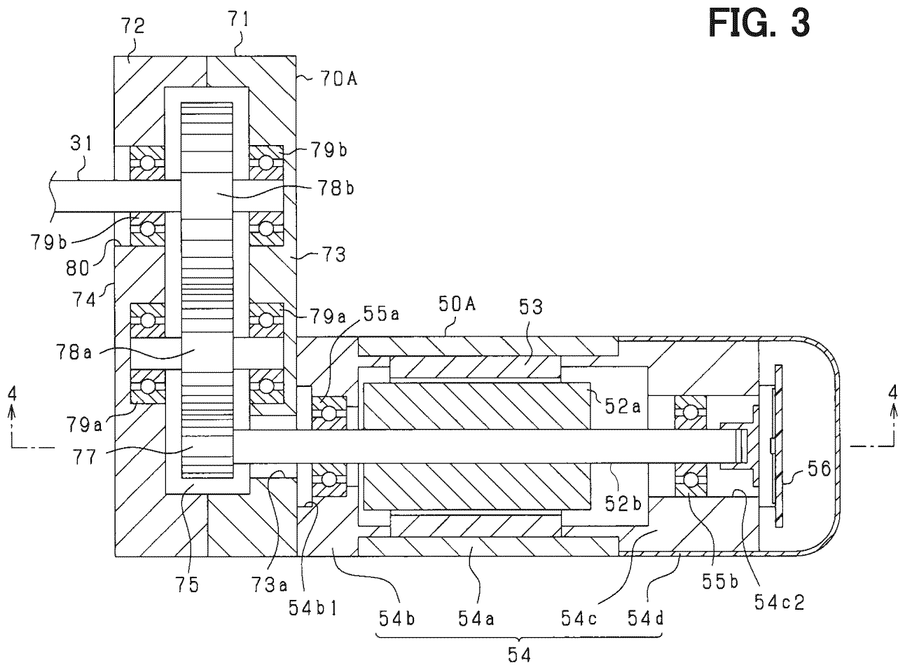

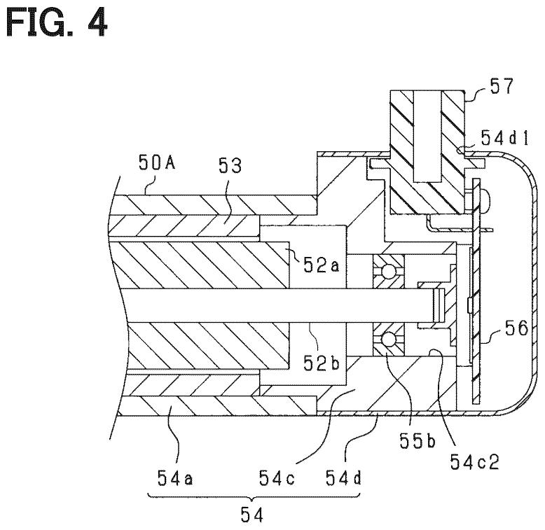

The first electric motor 50A and the first speed reducer 70A are integrally formed together and thereby form a first electric drive device, and the second electric motor 50B and the second speed reducer 70B are integrally formed together and thereby form a second electric drive device. The first electric drive device and the second electric drive device may individually serve as the electric drive device of present disclosure or may cooperate together to serve as the electric drive device of present disclosure. In the present embodiment, the structure of the first electric drive device is basically the same as the structure of the second electric drive device. For this reason, the first electric drive device will be described as an example with reference to FIGS. 3 and 4. FIG. 4 is a cross-sectional view taken along line 4-4 in FIG. 3 and shows the first electric motor 50A.

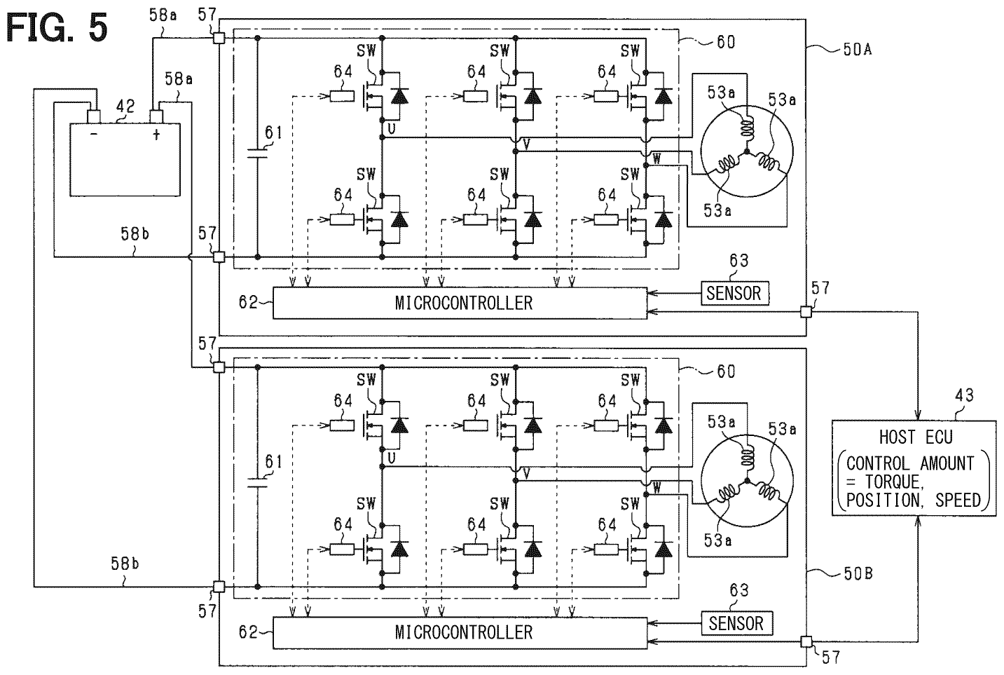

First, an example of the first electric motor 50A will be described. The first electric motor 50A includes: a rotor 52a which includes a plurality of field magnetic poles (e.g., a plurality of permanent magnets); a shaft 52b which is fixed to the rotor 52a; and a stator 53 which is placed on the radially outer side of the rotor 52a. The stator 53 includes: a stator core; and a plurality of stator windings 53a (see FIG. 5) which are wound around the stator core.

The first electric motor 50A includes a motor housing 54. The motor housing 54 includes a cylindrical tubular portion 54a, a first connecting portion 54b, a second connecting portion 54c and a cover portion 54d. The cylindrical tubular portion 54a is shaped in a cylindrical tubular form that is elongated in an extending direction of the shaft 52b. The first connecting portion 54b is placed at a first end of the cylindrical tubular portion 54a in a longitudinal direction of the cylindrical tubular portion 54a, and the second connecting portion 54c is placed at a second end of the cylindrical tubular portion 54a in the longitudinal direction of the cylindrical tubular portion 54a. The rotor 52a and the stator 53 are received in a cylindrical space surrounded by the cylindrical tubular portion 54a, the first connecting portion 54b and the second connecting portion 54c. The stator 53 is fixed to an inner peripheral surface of the cylindrical tubular portion 54a. In FIG. 2 and other drawings, indication of a boundary between the first connecting portion 54b and the cylindrical tubular portion 54a at the motor housing 54 is omitted for the sake of simplicity.

A first opening 54b1 is formed at the first connecting portion 54b, and a first motor bearing 55a is installed at the first opening 54b1. Furthermore, a second opening 54c2 is formed at the second connecting portion 54c, and a second motor bearing 55b is installed at the second opening 54c2. In the present embodiment, each of the first and second motor bearings 55a, 55b is a rolling bearing that includes an inner race, an outer race and a plurality of rollers. A first end part of the shaft 52b is rotatably supported by the first motor bearing 55a, and a second end part of the shaft 52b is rotatably supported by the second motor bearing 55b.

The cover portion 54d is installed to a part of the second connecting portion 54c which is opposite to the cylindrical tubular portion 54a in a longitudinal direction of the motor housing 54. A control circuit board 56 is installed in a space surrounded by the second connecting portion 54c and the cover portion 54d. In the present embodiment, the control circuit board 56 is arranged such that a plate surface of the control circuit board 56 is perpendicular to the extending direction of the shaft 52b. A connector opening 54d1 is formed through the cover portion 54d. A connector 57, which is electrically connected to the control circuit board 56, is inserted through the connector opening 54d1. The connector 57 includes an electric power source connector and a communication connector.

As described above, in the present embodiment, the motor housing 54, which is integrally formed with the first speed reducer 70A, receives: the rotor 52a; the stator 53; and the control circuit board 56 installed with inverters 60 and the other components. Therefore, electrical wirings, which electrically connect the stator windings 53a to the inverter 60, can be received in the motor housing 54, and thereby the structure of the electric drive device can be simplified.

Next, the first speed reducer 70A will be described.

The first speed reducer 70A includes a housing 71. The housing 71 includes a peripheral wall 72. The peripheral wall 72 includes a first wall portion 73 and a second wall portion 74 which are opposed to each other in a horizontal direction. The housing 71 includes a bottom plate portion 75 and a top plate portion 76. The bottom plate portion 75 is formed at a lower end part of the peripheral wall 72, and the top plate portion 76 is formed at an upper end part of the peripheral wall 72. The housing 71 is shaped in an elongated rectangular parallelepiped form and has a longitudinal direction which intersects the longitudinal direction of the motor housing 54. More specifically, the longitudinal direction of the housing 71 is perpendicular to the longitudinal direction of the motor housing 54.

An end part of the first wall portion 73, which faces in the longitudinal direction of the housing 71 and is adjacent to the first connecting portion 54b, is joined to the first connecting portion 54b by fastening members, such as bolts. A first drive side opening 73a is formed at a part of the first wall portion 73 which is opposed to the first connecting portion 54b. Therefore, the inside space of the housing 71 and the inside space of the motor housing 54 are communicated with each other through the first opening 54b1 and the first drive side opening 73a. The first opening 54b1 and the first drive side opening 73a serve as a motor-side opening that extends through a connection between the motor housing 54 and the first wall portion 73.

One example of the internal structure of the housing 71 will be described. The first end part of the shaft 52b extends into the inside space of the housing 71 through the first opening 54b1 and the first drive side opening 73a. A plurality of spur gears are received in a space (receiving space) which is surrounded by the peripheral wall 72, the bottom plate portion 75 and the top plate portion 76. Specifically, a motor-side rotatable body 77, a first gear 78a and a second gear 78b are received in this space. The motor-side rotatable body 77, the first gear 78a and the second gear 78b are arranged in this order from the first drive side opening 73a side. The first end part of the shaft 52b is coupled to the motor-side rotatable body 77.

A first bearing 79a and a second bearing 79b (serving as drive-side rotatable bodies) are installed to each of the first wall portion 73 and the second wall portion 74. In the present embodiment, each of the first and second bearings 79a, 79b is a rolling bearing that includes an inner race, an outer race and a plurality of rollers. The first gear 78a is rotatably supported by the first bearings 79a, and the second gear 78b is rotatably supported by the second bearings 79b. A rotational axis of the motor-side rotatable body 77, a rotational axis of the first gear 78a and a rotational axis of the second gear 78b extend in the extending direction of the shaft 52b.

External teeth of the motor-side rotatable body 77 are configured to mesh with external teeth of the first gear 78a, and a diameter of the motor-side rotatable body 77 is smaller than a diameter of the first gear 78a. Furthermore, the external teeth of the first gear 78a are configured to mesh with external teeth of the second gear 78b, and the diameter of the first gear 78a is smaller than a diameter of the second gear 78b. That is, the diameters of the gears, which are received in the housing 71, are increased from the first drive side opening 73a side toward a second drive side opening 80 (described later) side in the longitudinal direction of the housing 71. With this configuration, the rotational speed of the second gear 78b is reduced relative to the rotational speed of the motor-side rotatable body 77, and an input torque transmitted from the motor-side rotatable body 77 to the second gear 78b is increased and is outputted from the second gear 78b. Furthermore, since the motor-side rotatable body 77, the first gear 78a and the second gear 78b are the spur gears, a size of the first speed reducer 70A, which is measured in a width direction (hereinafter referred to as a vehicle width direction) of the electric wheelchair 10, can be reduced, and thereby a size of the electric wheelchair 10, which is measured in the vehicle width direction, can be reduced. By reducing the size of the electric wheelchair 10 measured in the vehicle width direction, it is possible to reduce restrictions on the movement of the electric wheelchair 10 at places (e.g., a door of an elevator where a passage width is narrow). This size reduction of the electric wheelchair 10 can improve the convenience of a user (e.g., a person requiring care) who uses the electric wheelchair 10.

The second drive side opening 80 is formed at a part of the second wall portion 74 where the second bearing 79b is installed. A drive shaft 31 is inserted through the second drive side opening 80. The drive shaft 31 extends in the extending direction of the shaft 52b. The second gear 78b is coupled to a first end part of the drive shaft 31, and a corresponding one of the rear wheels 30 is coupled to a second end part of the drive shaft 31.

The electric drive device of the present embodiment is configured to enable a reduction in the size of the electric drive device measured in the vehicle width direction. As shown in FIG. 2, a portion of the housing 71 of the first speed reducer 70A, which is adjacent to the drive shaft 31 of the first speed reducer 70A in the longitudinal direction of the housing 71 of the first speed reducer 70A, and a portion of the housing 71 of the second speed reducer 70B, which is adjacent to the drive shaft 31 of the second speed reducer 70B in the longitudinal direction of the housing 71 of the second speed reducer 70B, are opposed to each other in the extending direction (the vehicle width direction) of the shaft 52b of the first or second electric motor 50A, 50B. Furthermore, the drive shaft 31 of the first speed reducer 70A and the drive shaft 31 of the second speed reducer 70B are coaxial with each other. The left rear wheel 30 is coupled to the drive shaft 31 of the first speed reducer 70A, and the right rear wheel 30 is coupled to the drive shaft 31 of the second speed reducer 70B.

The portion of the housing 71 of the first speed reducer 70A, which is adjacent to the drive shaft 31 of the first speed reducer 70A in the longitudinal direction of the housing 71 of the first speed reducer 70A, is opposed to a peripheral surface of the motor housing 54 of the second electric motor 50B (specifically, an outer peripheral surface of the cylindrical tubular portion 54a, an outer peripheral surface of the second connecting portion 54c and an outer peripheral surface of the cover portion 54d). The portion of the housing 71 of the second speed reducer 70B, which is adjacent to the drive shaft 31 of the second speed reducer 70B in the longitudinal direction of the housing 71 of the second speed reducer 70B, is opposed to a peripheral surface of the motor housing 54 of the first electric motor 50A. With this configuration, the size of the electric drive device, which is measured in the vehicle width direction, can be reduced.

Next, with reference to FIG. 5, the electrical structure of the first electric motor 50A and the second electric motor 50B will be described.

The first electric motor 50A includes the inverter 60 that serves as an electrical power converter. The inverter 60 includes upper and lower switches SW for each of the three phases. In the present embodiment, each of the switches SW is a voltage-controlled semiconductor switching device, specifically a SiC N-channel MOSFET. Therefore, in the switch SW, a high potential terminal is a drain, and a low potential terminal is a source. The switch SW includes a body diode. The switch SW may be an IGBT, for example. In this case, in the switch SW, a high potential terminal is a collector, and a low potential terminal is an emitter.

At each phase, a first end of a smoothing capacitor 61 is connected to the drain of the upper arm switch SW. At each phase, the drain of the lower arm switch SW is connected to the source of the upper arm switch SW. At each phase, a second end of the smoothing capacitor 61 is connected to the source of the lower arm switch SW. At each phase, a first end of the corresponding stator winding 53a is connected to the source of the upper arm switch SW and the drain of the lower arm switch SW. A second end of the stator winding 53a of each phase is connected to a neutral point.

Like the first electric motor 50A, the second electric motor 50B includes the inverter 60 and the smoothing capacitor 61. The structure of the second electric motor 50B is basically the same as the structure of the first electric motor 50A. For this reason, a detailed description of the second electric motor 50B is omitted hereafter as appropriate.

At each inverter 60, a positive terminal of the electricity storage device 42 is connected to the first end of the smoothing capacitor 61 through the electric power source connector of the connector 57 and a first electric power cable 58a. At each inverter 60, a negative terminal of the electricity storage device 42 is connected to the second end of the smoothing capacitor 61 through the electric power source connector and a second electric power cable 58b. Instead of the single electricity storage device 42, two electricity storage devices 42 may be respectively provided to the two inverters 60.

The first electric motor 50A includes: a microcontroller 62 (corresponding to a controller); a sensor (sensor unit) 63; and a plurality of drive ICs 64. In the present embodiment, the drive IC 64 is individually provided to each switch SW. The sensor 63 includes: an angle sensor which senses a rotational angular position (electric angle) of the first electric motor 50A; and an electric current sensor which senses an electric current conducted in the stator windings 53a. Measurement values of the sensor 63 are inputted to the microcontroller 62.

In order to control the control amount of the first electric motor 50A to a command value based on each measurement value, the microcontroller 62 performs the switching control operation of each switch SW of the inverter 60. In order to turn on the upper arm switch SW and the lower arm switch SW alternately at each phase, the microcontroller 62 generates drive signals, which respectively correspond to the upper and lower arm switches SW. The microcontroller 62 outputs the generated drive signals to the drive ICs 64. The microcontroller 62, the drive ICs 64, and the inverter 60 are installed to the control circuit board 56. In order to control the control amount of the second electric motor 50B to a command value, the microcontroller 62 of the second electric motor 50B performs the switching control operation of each switch SW of the inverter 60 of the second electric motor 50B.

A host ECU 43 is installed in the enclosure 41. An input signal of the manipulator 25 is inputted to the host ECU 43. The host ECU 43 exchanges information with the microcontroller 62 of each electric motor 50A, 50B through the communication connector of the connector 57 of each electric motor 50A, 50B.

In order to implement the desired control operation, such as a travel control operation of the electric wheelchair 10, the host ECU 43 transmits the command value of the control amount to the microcontrollers 62 of each electric motor 50A, 50B through the communication connector. The control amount is, for example, a torque (a torque of the electric motor); a rotational speed (or electrical angular velocity) of the rotor 52a; or a rotational angular position of the rotor 52a.

For example, if the host ECU 43 determines that straight travel of the electric wheelchair 10 is commanded based on the input signal from the manipulator 25, the host ECU 43 sends a rotational speed command value to the microcontroller 62 of each electric motor 50A, 50B in such a way that the left and right rear wheels 30 are rotated in the same direction and at the same rotational speed.

For example, if the host ECU 43 determines that turn travel of the electric wheelchair 10 is commanded based on the input signal from the manipulator 25, the host ECU 43 sends a rotational speed command value to the microcontroller 62 of each electric motor 50A, 50B in such a way that the left and right rear wheels 30 are rotated in the same direction, and the rotational speed of the corresponding one of the left and right rear wheels 30, which is located on the commanded turning side, is decreased in comparison to the rotational speed of the other one of the left and right rear wheels 30. For example, if a right turn is commanded, the rotational speed command value of the right rear wheel 30 is decreased relative to the rotational speed command value of the left rear wheel 30. The host ECU 43 can also send the rotational speed command value to the microcontroller 62 of each electric motor 50A, 50B in such a way that the left and right rear wheels 30 are rotated in opposite directions, respectively, which are opposite to each other. In this case, the electric wheelchair 10 makes a spin turn.

For example, in a case where the electric wheelchair 10 is travelling along slope road, if the host ECU 43 determines that a stop of the electric wheelchair 10 is commanded based on the input signal from the manipulator 25, the host ECU 43 sends a command value of a rotational angular position to the microcontroller 62 of each electric motor 50A, 50B in such a way that the rotation of the rotor 52a of each electric motor 50A, 50B is stopped. Therefore, if the joystick is not operated by the user, the rotational angular position is fixed to the command value, and a hill-hold control operation of the electric wheelchair 10 is implemented.

For example, if the host ECU 43 determines that braking of the electric wheelchair 10 is commanded, the host ECU 43 sends a torque command value to the microcontroller 62 of each electric motor 50A, 50B to generate a braking torque at each electric motor 50A, 50B. Therefore, a braking force is applied to the electric wheelchair 10, and the electric wheelchair 10 then stops.

According to the present embodiment described above, it is possible to provide a highly convenient electric wheelchair 10 while simplifying the structure of the drive unit 40.

### (Modifications of First Embodiment)

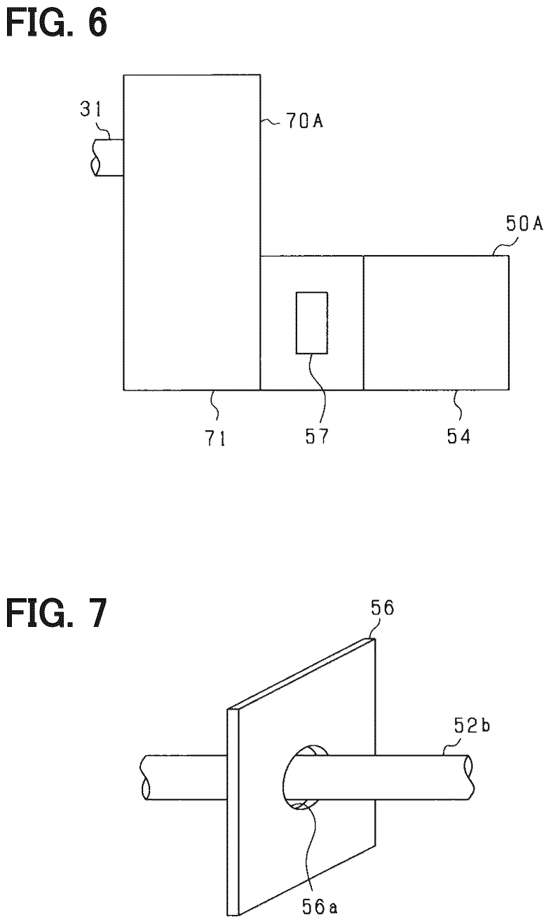

Taking the first electric motor 50A as an example, with reference to FIG. 6, the control circuit board 56, which is provided with the connector 57, may be placed in the motor housing 54 at the one side which is adjacent to the first speed reducer 70A in the longitudinal direction of the motor housing 54, and the rotor 52a and the stator 53 may be placed in the motor housing 54 at the opposite side which is opposite to the first speed reducer 70A in the longitudinal direction of the motor housing 54. In this case, as shown in FIG. 7, the control circuit board 56 may have a through-hole 56a through which the shaft 52b is inserted.

The drive unit 40 may not have the host ECU 43. In this case, for example, the microcontrollers 62 of the electric motors 50A, 50B may communicate with each other, and one of the microcontrollers 62 may function as a master, and the other one of the microcontrollers 62 may function as a slave.

### Second Embodiment

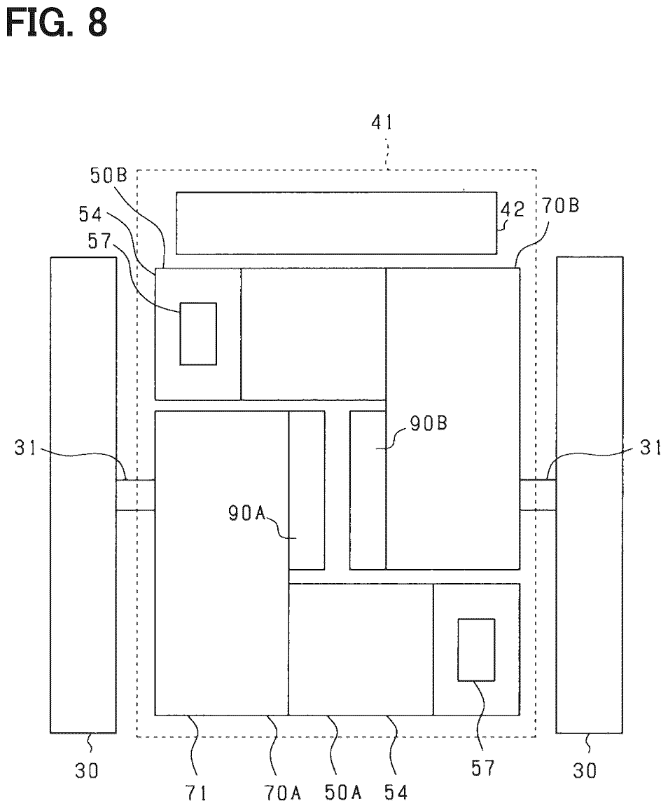

Hereafter, a second embodiment will be described with reference to the drawings, focusing on the differences from the first embodiment. In the present embodiment, as shown in FIG. 8, the enclosure 41 receives a first braking device 90A and a second braking device 90B. In the drawings of the second embodiment, the same portions as those shown in FIG. 2 are indicated with the same reference signs for the sake of convenience.

The first braking device 90A is integrally formed with the first speed reducer 70A, and the second braking device 90B is integrally formed with the second speed reducer 70B. Each of the braking devices 90A, 90B of the present embodiment is an electromagnetic brake. The braking device is not limited to the electromagnetic brake.

The first braking device 90A is coupled to a part of the first wall portion 73, which is opposed to the drive shaft 31, at the housing 71 of the first speed reducer 70A. The second braking device 90B is coupled to a part of the first wall portion 73, which is opposed to the drive shaft 31, at the housing 71 of the second speed reducer 70B. That is, each braking device 90A, 90B is placed in a space that is held between the speed reducers 70A, 70B in the vehicle width direction and is also held between the electric motors 50A, 50B in a vehicle longitudinal direction (i.e., a longitudinal direction of the electric wheelchair 10). With this configuration, the size of the enclosure 41 can be reduced.

In the present embodiment, the first braking device 90A applies a braking force through contact with the second gear 78b or the drive shaft 31 of the first speed reducer 70A. In the present embodiment, the second braking device 90B applies a braking force through contact with the second gear 78b or the drive shaft 31 of the second speed reducer 70B.

The first braking device 90A is controlled by the microcontroller 62 of the first electric motor 50A, and the second braking device 90B is controlled by the microcontroller 62 of the second electric motor 50B. Specifically, in a case where the host ECU 43 determines that the manipulator 25 is not manipulated based on the input signal from the manipulator 25, the host ECU 43 outputs a braking command to the microcontroller 62 of each electric motor 50A, 50B. The microcontroller 62 of the first electric motor 50A controls the first braking device 90A in the case where the braking command is received, and thereby the first braking device 90A applies the braking force to the second gear 78b or the drive shaft 31 of the first speed reducer 70A. The microcontroller 62 of the second electric motor 50B controls the second braking device 90B in the case where the braking command is received, and thereby the second braking device 90B applies the braking force to the second gear 78b or the drive shaft 31 of the second speed reducer 70B. Therefore, when the user of the electric wheelchair 10 stops the manipulation of the joystick, which is the manipulator 25, the electric wheelchair 10 is stopped by the braking.

### (Modifications of Second Embodiment)

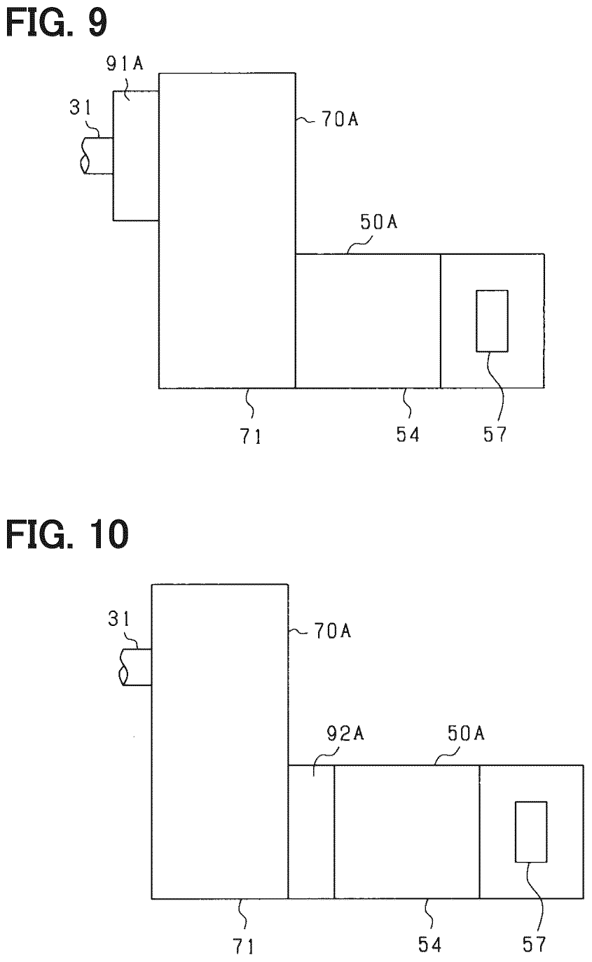

As shown in FIG. 9, in the first electric drive device, a first braking device 91A may be coupled to the second wall portion 74 of the housing 71. In this case, the first braking device 91A applies the braking force to the drive shaft 31. This modification is also equally applicable to the second electric drive device.

As shown in FIG. 10, in the first electric drive device, the first braking device 92A may be coupled between the first speed reducer 70A and the motor housing 54 of the first electric motor 50A. In this case, the first braking device 92A may contact, for example, the shaft 52b to apply the braking force to the shaft 52b. This modification is also equally applicable to the second electric drive device.

According to this configuration, since the braking force is applied to the shaft 52b before the reduction of the rotational speed of the shaft 52b by the speed reducer takes place, it is possible to reduce the braking force to be applied from the braking device. With this configuration, the size of the braking device can be reduced.

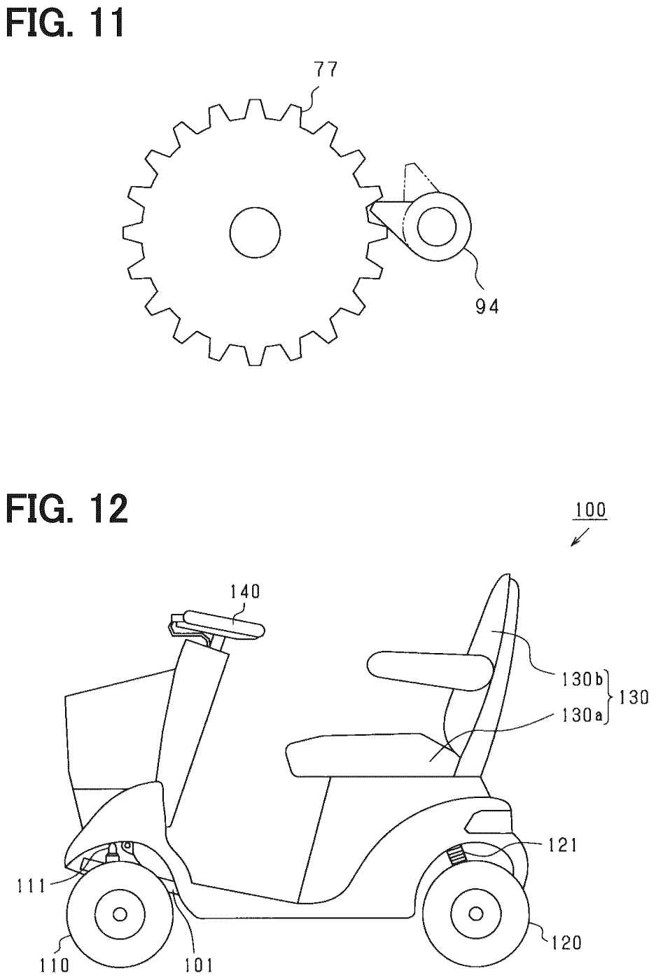

As shown in FIG. 11, in each of the first and second electric drive devices, the braking device may be placed at the inside of the housing 71 of the speed reducer. Specifically, the braking device includes a stopper member 94. The stopper member 94 is configured to rotate about a rotational axis thereof to a first position indicated with a solid line or a second position indicated with a dot-dash line in FIG. 11. When the stopper member 94 is rotated to the first position, the stopper member 94 is meshed with the external teeth of the motor-side rotatable body 77, and thereby the stopper member 94 stops the rotation of the motor-side rotatable body 77. In contrast, when the stopper member 94 is rotated to the second position, the stopper member 94 is spaced apart from the motor-side rotatable body 77, and thereby the rotation of the motor-side rotatable body 77 is enabled. The rotation of the stopper member 94 may be controlled by the microcontroller 62.

### Third Embodiment

Hereafter, a third embodiment will be described with reference to the drawings, focusing on the differences from the first embodiment. As shown in FIG. 12, the compact mobility of the present embodiment is a senior car that is an electric vehicle. A user of the senior car is, for example, an elderly. In the drawings of the third embodiment, the same portions as those shown in FIG. 2 are indicated with the same reference signs for the sake of convenience.

The electric vehicle 100 has a vehicle body frame 101. Left and right front wheels 110 are placed at a front side of the vehicle body frame 101. Left and right rear wheels 120 are arranged at a rear side of the vehicle body frame 101. A handle unit 140, which is a manipulator for steering the electric vehicle 100, is placed on the upper side of the front wheels 110. Each of the front wheels 110 is installed to the vehicle body frame 101 through an axle and a suspension 111. Each of the rear wheels 120 is installed to the vehicle body frame 101 through an axle and a suspension 121. In the present embodiment, the left and right front wheels 110 are steering wheels, and the left and right rear wheels 120 are drive wheels which are driven to rotate by a drive unit described later.

The electric vehicle 100 includes a seat 130. The seat 130 includes a seat portion 130a and a backrest portion 130b.

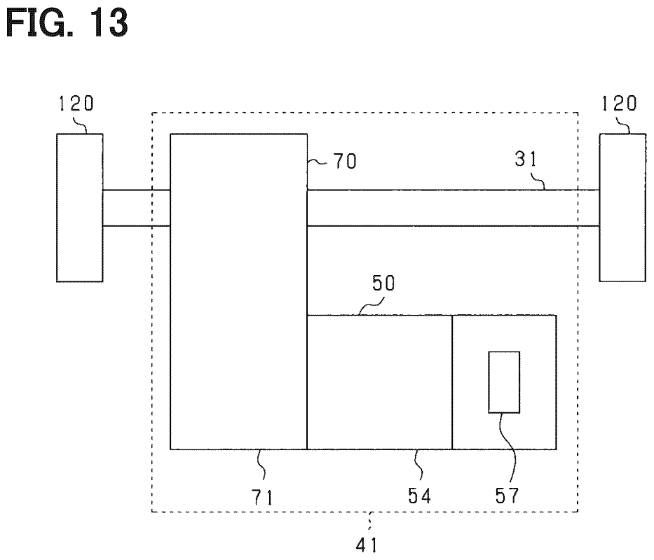

The electric vehicle 100 includes the drive unit fixed to the vehicle body frame 101. FIG. 13 shows a structure at the inside of the enclosure 41 of the drive unit of the present embodiment. The drive unit has the structure corresponding to the first electric drive device of the first embodiment and does not have the structure corresponding to the second electric drive device. In the structure shown in FIG. 13, an electric motor 50 corresponds to the first electric motor 50A, and a speed reducer 70 corresponds to the first speed reducer 70A.

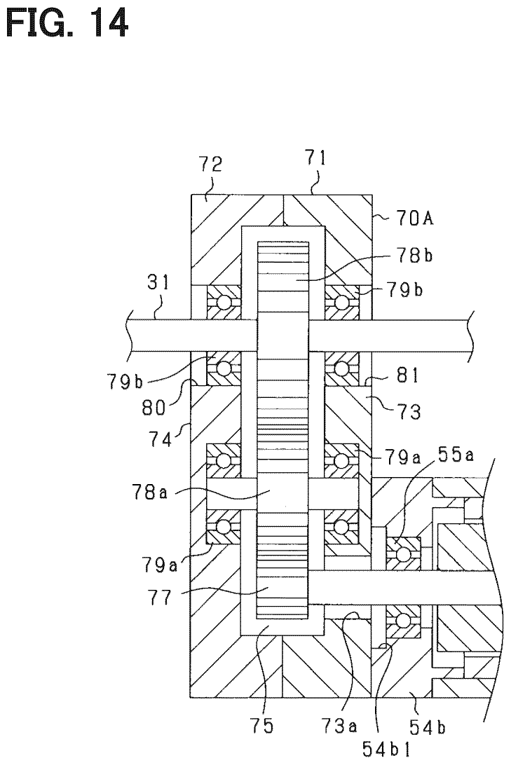

FIG. 14 shows an example of an internal structure of the housing 71 of the speed reducer 70.

A third drive side opening 81 is formed to extend through a part of the first wall portion 73 where the second bearing 79b is installed. The third drive side opening 81 is formed to extend through the first wall portion 73 at a location where the third drive side opening 81 is opposed to the second drive side opening 80 in the extending direction of the shaft 52b. The drive shaft 31, which extends from the second drive side opening 80, is inserted through the third drive side opening 81. The second gear 78b is coupled to an intermediate portion of the drive shaft 31. The left rear wheel 120 is coupled to a first end of the drive shaft 31, and the right rear wheel 120 is coupled to a second end of the drive shaft 31.

Like in the first embodiment, the host ECU 43 sends a command value of the control amount of the electric motor 50 to the microcontroller 62 of the electric motor 50. Thereby, the straight travel and the turn travel of the electric vehicle 100 can be executed like in the first embodiment.

### Fourth Embodiment

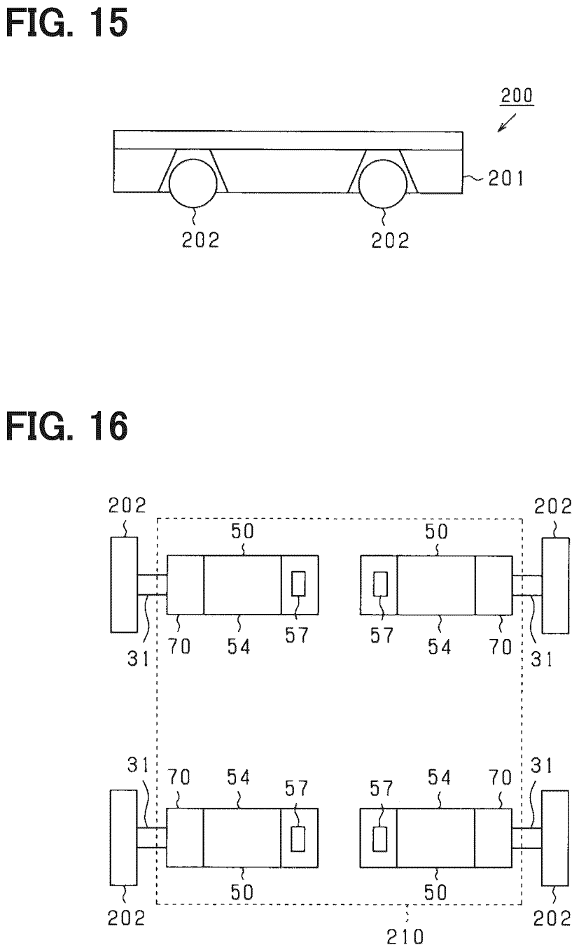

Hereafter, a fourth embodiment will be described with reference to the drawings, focusing on the differences from the first and third embodiments. As shown in FIG. 15, the compact mobility of the present embodiment is an automatic guided vehicle (AGV) 200 that is an electric vehicle. In the drawings of the fourth embodiment, the same portions as those shown in FIGS. 2 and 13 are indicated with the same reference signs for the sake of convenience.

The automatic guided vehicle 200 includes a vehicle body 201 and a plurality of drive wheels 202. In the present embodiment, the plurality of drive wheels 202 are left and right front wheels and left and right rear wheels.

As shown in FIG. 16, the enclosure 210 of the drive unit of the automatic guided vehicle 200 receives a plurality of electric drive devices which correspond to the plurality of drive wheels 202, respectively. These electric drive devices may individually serve as the electric drive device of present disclosure or may cooperate together to serve as the electric drive device of present disclosure. In the speed reducer 70 of each electric drive device, the drive shaft 31 and the shaft 52b are coaxial with each other unlike the speed reducer shown in FIG. 2. In this case, the speed reducer 70 is a speed reducer that includes, for example, a planetary gear mechanism or a cycloidal gear mechanism.

The microcontroller 62 of each electric motor 50 is configured to execute intercommunication with the host ECU 43 (not shown) through the communication connector of the connector 57.

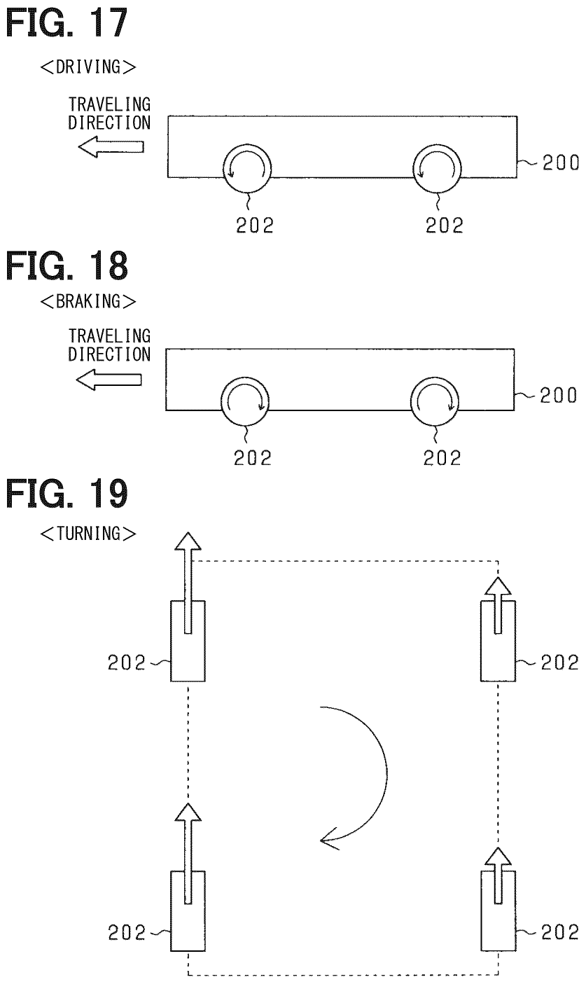

If the host ECU 43 determines that the straight travel of the automatic guided vehicle 200 is commanded, the host ECU 43 sends a rotational speed command value to the microcontroller 62 of each electric motor 50 in such a way that the left and right drive wheels 202 are rotated in the same direction and at the same rotational speed, as shown in FIG. 17.

If the host ECU 43 determines that braking of the automatic guided vehicle 200 is commanded, the host ECU 43 sends a torque command value to the microcontroller 62 of each electric motor 50 to generate a braking torque at each electric motor 50, as shown in FIG. 18. Therefore, a braking force is applied to the automatic guided vehicle 200, and the automatic guided vehicle 200 then stops.

If the host ECU 43 determines that the turn travel of the automatic guided vehicle 200 is commanded, the host ECU 43 sends a rotational speed command value to the microcontroller 62 of each electric motor 50 in such a way that the left and right drive wheels 202 are rotated in the same direction, and the rotational speed of the corresponding ones of the left and right drive wheels 202, which are located on the commanded turning side, is decreased in comparison to the rotational speed of the other ones of the left and right drive wheels 202. In an example shown in FIG. 19, the host ECU 43 determines that the right turn travel of the automatic guided vehicle 200 is commanded. In this case, the host ECU 43 sends a rotational speed command value to the microcontroller 62 of each electric motor 50 in such a way that the rotational speed of the right drive wheels 202 is decreased in comparison to the rotational speed of the left drive wheels 202.

The host ECU 43 can also send the rotational speed command value to the microcontroller 62 of each electric motor 50 in such a way that the left and right drive wheels 202 are rotated in opposite directions, respectively, which are opposite to each other. In this case, the automatic guided vehicle 200 makes a spin turn.

### Other Embodiments

The above-described embodiments may be modified as follows.

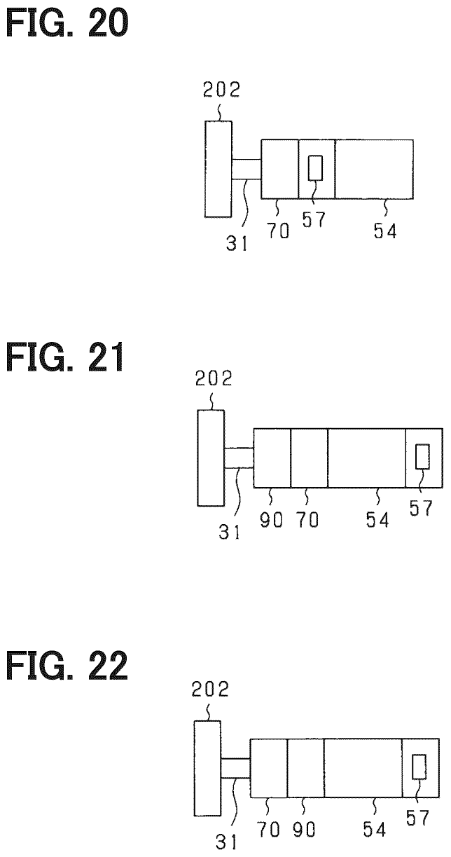

The structure of each electric drive device shown in FIG. 16 may be changed to a structure shown in FIG. 20. Specifically, the speed reducer 70; the control circuit board 56; and the rotor 52a and the stator 53 are arranged in this order from the drive shaft 31 side in the motor housing 54.

Furthermore, as shown in FIG. 21, a braking device 90, which applies a braking force to the drive shaft 31, may be coupled to the speed reducer 70. Furthermore, in the structure having the speed reducer 70, as shown in FIG. 22, the speed reducer 70; the braking device 90; the rotor 52a and the stator 53; and the control circuit board 56 may be arranged in this order from the drive shaft 31 side.

The electric drive device of each of the embodiments described above may be used at any of the electric wheelchair, the senior car and the automated guided vehicle. For example, at the automated guided vehicle or the senior car, the left and right front wheels may be rotated by the electric drive devices of the first embodiment, and the left and right rear wheels may be rotated by the electric drive devices of the first embodiment. Furthermore, at the senior car, the left and right front and rear wheels may be rotated by the electric drive devices shown in FIG. 16. In this case, the senior car can make a spin turn.

A drive subject member, which is coupled to the drive shaft of the speed reducer is not limited to the wheel and may be, for example, a sprocket member. In this case, for example, a rotational drive force may be transmitted from the sprocket member to the drive wheel(s) through a chain or a belt.

The motor housing is not limited to be shaped in the cylindrical tubular form. For example, the motor housing may be shaped in a form having, for example, a transverse cross-section shaped in a rectangular form.

The electric motor is not limited to the inner rotor type and may be an outer rotor type.

The connector is not limited to the connector that has the communication connector and the electric power source connector which are integrally formed together. The communication connector and the electric power source connector may be separately formed.

The controller and its control method of the present disclosure may be realized by a dedicated computer that is provided by configuring at least one processor and a memory programmed to perform one or more functions embodied by a computer program. Alternatively, the controller and its control method of the present disclosure may be realized by a dedicated computer that is provided by configuring at least one processor with one or more dedicated hardware logic circuits. Further alternatively, the controller and its control method of the present disclosure may be realized by one or more dedicated computers that are provided by configuring a combination of: a processor programmed to perform one or more functions and a memory; and a processor composed of one or more hardware logic circuits. Further, the computer program may also be stored in a computer-readable, non-transitory, tangible storage medium as instructions to be executed by a computer.

Although the present disclosure has been described with reference to the embodiments and the modifications, it is understood that the present disclosure is not limited to the embodiments and the modifications and structures described therein. The present disclosure also includes various variations and variations within the equivalent range. Also, various combinations and forms, as well as other combinations and forms that include only one element, more, or less, are within the scope and ideology of the present disclosure.

What is claimed is:

1. An electric drive device comprising:
an electric motor that includes:
a rotor;
a stator that is radially opposed to the rotor;
an electrical power converter that is electrically connected to a plurality of stator windings of the stator and is configured to supply an electric current to the plurality of stator windings when a switching control operation of the electrical power converter is executed; and
a motor housing that is shaped in a tubular form which is elongated in an extending direction of a shaft of the rotor, wherein the motor housing receives the rotor, the stator and the electrical power converter in a space inside the motor housing; and
a speed reducer that includes:
a motor-side rotatable body that is coupled to the shaft; and
a drive-side rotatable body, wherein the speed reducer is configured to reduce a rotational speed of the drive-side rotatable body relative to a rotational speed of the motor-side rotatable body, wherein:
the motor housing and the speed reducer are integrally formed together.

2. The electric drive device according to claim 1, wherein:
the speed reducer includes a housing that has a peripheral wall, wherein the peripheral wall has a first wall portion and a second wall portion which are opposed to each other, and the housing receives the motor-side rotatable body in a receiving space which is surrounded by the peripheral wall;
the first wall portion is joined to an end part of the motor housing which faces the first wall portion in a longitudinal direction of the motor housing;
a motor-side opening extends in the extending direction of the shaft through a connection between the motor housing and the first wall portion;
the motor-side rotatable body and the shaft are coupled together through the motor-side opening;
the second wall portion has a drive-side opening through which a drive shaft coupled to the drive-side rotatable body is inserted;
a rotational axis of the motor-side rotatable body and a rotational axis of the drive-side rotatable body extend in the extending direction of the shaft; and
the rotor and the stator are placed in the motor housing at one side which is adjacent to the motor-side opening in the longitudinal direction of the motor housing, and the electrical power converter is placed in the motor housing at an opposite side which is opposite to the motor-side opening in the longitudinal direction of the motor housing.

3. The electric drive device according to claim 1, wherein:
the speed reducer includes a housing that has a peripheral wall, wherein the peripheral wall has a first wall portion and a second wall portion which are opposed to each other, and the housing receives the motor-side rotatable body in a receiving space which is surrounded by the peripheral wall;
the first wall portion is joined to an end part of the motor housing which faces the first wall portion in a longitudinal direction of the motor housing;
a motor-side opening extends in the extending direction of the shaft through a connection between the motor housing and the first wall portion;
the motor-side rotatable body and the shaft are coupled together through the motor-side opening;
the second wall portion has a drive-side opening through which a drive shaft coupled to the drive-side rotatable body is inserted;
a rotational axis of the motor-side rotatable body and a rotational axis of the drive-side rotatable body extend in the extending direction of the shaft; and
the electrical power converter is placed in the motor housing at one side which is adjacent to the motor-side opening in the longitudinal direction of the motor housing, and the rotor and the stator are placed in the motor housing at an opposite side which is opposite to the motor-side opening in the longitudinal direction of the motor housing.

4. The electric drive device according to claim 2, wherein:
the housing is shaped to have a longitudinal direction which intersects the longitudinal direction of the motor housing;
the first wall portion has a drive-side opening, wherein the drive-side opening of the first wall portion and the drive-side opening of the second wall portion are placed at a location which is displaced from the motor-side opening in the longitudinal direction of the housing;
the drive-side opening of the first wall portion is placed to oppose the drive-side opening of the second wall portion;
the drive shaft is inserted through the drive-side opening of the first wall portion and the drive-side opening of the second wall portion; and
two drive wheels are respectively coupled to two opposite end parts of the drive shaft which are opposite to each other.

5. The electric drive device according to claim 2, wherein:
the housing is shaped to have a longitudinal direction which intersects the longitudinal direction of the motor housing;
the drive-side opening is formed at the second wall portion at a location which is displaced from the motor-side opening in the longitudinal direction of the housing;
the electric motor is one of a plurality of electric motors that include a first electric motor and a second electric motor;
the speed reducer is one of a plurality of speed reducers that include:
a first speed reducer which is integrally formed with the first electric motor; and
a second speed reducer which is integrally formed with the second electric motor;
a portion of the housing of the first speed reducer, which is adjacent to the drive-side opening of the first speed reducer in the longitudinal direction of the housing of the first speed reducer, is opposed in the extending direction of the shaft of the first electric motor to a portion of the housing of the second speed reducer, which is adjacent to the drive-side opening of the second speed reducer in the longitudinal direction of the housing of the second speed reducer;
the portion of the housing of the first speed reducer, which is adjacent to the drive-side opening of the first speed reducer in the longitudinal direction of the housing of the first speed reducer, is opposed to a peripheral surface of the motor housing of the second electric motor; and
the portion of the housing of the second speed reducer, which is adjacent to the drive-side opening of the second speed reducer in the longitudinal direction of the housing of the second speed reducer, is opposed to a peripheral surface of the motor housing of the first electric motor.

6. The electric drive device according to claim 5, wherein the motor-side rotatable body and the drive-side rotatable body are respectively formed as two spur gears which are arranged in the longitudinal direction of the housing at each of the first speed reducer and the second speed reducer.

7. The electric drive device according to claim 1, comprising at least one braking device which is provided to at least one of the electric motor and the speed reducer, wherein the at least one braking device is configured to apply a braking force that limits rotation of the shaft, the motor-side rotatable body and the drive-side rotatable body.

8. The electric drive device according to claim 7, wherein the at least one braking device is configured to apply the braking force to one of:
the shaft;
a drive shaft coupled to the drive-side rotatable body; and
a gear of the speed reducer.

9. The electric drive device according to claim 1, comprising a controller that is configured to execute the switching control operation of the electrical power converter, wherein:
the controller is configured to execute the switching control operation to control a control amount of the electric motor to a command value; and
the control amount is one of:
a torque;
a rotational angular position of the rotor; and
a rotational speed of the rotor.

10. The electric drive device according to claim 1, wherein the electric drive device is used as a driving power source of one of:
an electric wheelchair which includes at least one front wheel, at least one rear wheel and a user seat;
a compact electric vehicle which includes at least one front wheel, at least one rear wheel and a user seat; and
an automated guided vehicle that includes at least one wheel.
